(19) United States
(12) Patent Application Publication
(10) Pub. No.: US 2026/0289576 A1
(43) Pub. Date: Sep. 24, 2026

(54) Real-Time Clearing Updates

(71) Applicant: Mastercard International Incorporated, New York, NY (US)

(72) Inventors: Shrikant Salke, Pune (IN); Balamurali Balasubramanian, Puzhuthivakkam Chennai (IN); Frederic Yann Elie Le Garrec, New Rochelle, NY (US); Imani Smith, St. Louis, MO (US); Rajesh Konda Venkatesan, Plano, TX (US); Sachin Kumar Rathore, Pune (IN); Samantha Kristen Holder, St Louis Park, MN (US); Shrinivas Ambadas Kalvit, Pune (IN); Stephanie Detchemendy, Wentzville, MO (US)

(21) Appl. No.: 19/088,975

(22) Filed: Mar. 24, 2025

(51) Int. Cl. G06Q 20/42; G06Q 20/40

(52) U.S. Cl. CPC G06Q 20/42; G06Q 20/401

(57) ABSTRACT

The present invention relates to a computer-implemented method 300 for providing an update regarding a clearing status of a payment transaction, the method 300 comprising: receiving 304, at a clearing server 106, from an acquirer 104, a clearing request message, wherein the clearing request message comprises a request to initiate clearing of the payment transaction between the acquirer 104 and an issuer 108, processing 312, at the clearing server 106, the clearing of the payment transaction in response to receiving the clearing request message, generating 316, at the clearing server 106, a clearing request response message, wherein the clearing request response message comprises an acknowledgment of the clearing request message and a clearing status indicator, the clearing status indicator comprising an indication of a status of the clearing as a result of an outcome of the processing 312 step, transmitting 318, from the clearing server 106 to the acquirer 104, the clearing request response message, such that the acquirer 104 can take action based on the clearing request response message.

### FIELD

The present disclosure generally relates to methods and systems for providing real time clearing updates for payment transactions. In particular, the methods and systems allow for a clearing server to transmit, to an acquirer or a processor, real-time messages with updates on the completion or failure of a clearing process.

### BACKGROUND

Clearing is a fundamental step, when processing digital payment transactions. More specifically, clearing of a payment transaction consists in exchange of information between the parties involved in the transaction (e.g., the acquirer and the issuer) to ensure that funds are moved, from a sender to a receiver (e.g., from a seller to a buyer of certain goods and/or services), safely, correctly, and in compliance with financial regulations. Only after a payment transaction has been “cleared”, can the funds be moved from the sender's bank account to the receiver's bank account, in a final operation called “settlement”.

Whilst digital payments are becoming more and more common, there is a growing pressure for fast processing of digital payments, and, in particular, for fast completion of clearing processes.

However, traditional payment infrastructures are not suited for meeting these demands. In particular, traditional payment infrastructures clear transactions in batches, through the complex production of clearing reports, that are typically issued once a day, or once every few hours within a day. Sometimes, the production of the clearing reports is subject to significant delays. These timescales are not ideal in a world where transactions are becoming quicker.

It would therefore be desirable to have a system and a method to alleviate these problems relating to clearing of payment transactions.

### SUMMARY OF INVENTION

According to an aspect of the invention, there is provided a computer-implemented method for providing an update regarding a clearing status of a payment transaction, the method comprising: receiving, at a clearing server, from an acquirer, a clearing request message, wherein the clearing request message comprises a request to initiate clearing of the payment transaction between the acquirer and an issuer, processing, at the clearing server, the clearing of the payment transaction in response to receiving the clearing request message, generating, at the clearing server, a clearing request response message, wherein the clearing request response message comprises an acknowledgment of the clearing request message and a clearing status indicator, the clearing status indicator comprising an indication of a status of the clearing as a result of an outcome of the processing step, transmitting, from the clearing server to the acquirer, the clearing request response message, such that the acquirer can take action based on the clearing request response message.

Advantageously, the present invention enables the timely transmission of updates, to an acquirer participating in a payment transaction, regarding the clearing status of said payment transaction. For example, the invention may enable the instantaneous (or “real-time”) transmission of updates to a participating acquirer, regarding the clearing status of payment transactions. The updates may be provided immediately to the participating acquirers. The updates may be provided such that the acquirer can quickly take action based on said update. The update may be generated at (and provided from) the clearing server (which may act as a switch, in that it receives and transmits messages to/from the acquirer and the issuer), after the clearing server receives a clearing request message from the acquirer. The acquirer receives the update of the clearing status through a clearing status indicator, which is included in the clearing request response message generated by the clearing server immediately after processing the clearing of the payment transaction, such as in systems implementing real-time clearing, in response to the clearing request message sent by the acquirer. Notably, the clearing status indicator is generated, at the clearing server, immediately after processing the clearing request message from the acquirer. Notably, the clearing status indicator is generated by the clearing server and issued to the acquirer as quickly as an acknowledgment of receipt of the clearing request message.

In this way, in real-time clearing systems the acquirer may receive the update regarding the clearing status of the payment transaction in real-time. A real-time update on the clearing process may be defined as an update that is generated, in response to the clearing request message, by the clearing server, and that is transmitted to the acquirer at the same time as the acknowledgment of receipt of the clearing request message.

The acknowledgment of the clearing request message and the clearing status indicator may be sent together, as part of a single message, in the clearing request response message. In this way, the update on the clearing status may be provided to the acquirer simultaneously with the acknowledgment of receipt of the clearing request message.

Advantageously, the acquirer is able to promptly take action, based on the real-time update provided within the clearing request response message. More specifically, the acquirer does not need to wait to receive the reconciliation report (or clearing batch file(s)), which is generally issued once per day (e.g., at the end of business, or close of business, or any other set time), or at least once every several hours. This significantly reduces the time in which an acquirer is capable of responding (or reacting) to a clearing status update leading to accelerated understanding of liquidity status, and to a faster resolution for transactions that failed clearing, or, in some instances, to fewer failed transactions. For example, the acquirer can take action, based on the clearing request response message, and does not have to wait until after the clearing report is generated. Advantageously, the action can be timely tailored to the clearing status indicator (i.e., adapted to the outcome of the clearing processed at the clearing server). Another advantage is an improvement in liquidity and funds for the acquirer, and for the merchant.

In some arrangements, prior to the receiving step, the method comprises generating by the issuer an authorisation response message, in response to the issuer receiving an authorisation request message from the acquirer via an authorisation server. The method may further comprise transmitting, from the issuer to the acquirer, the authorisation response message, via the authorisation server.

In this way, an authorisation process is carried out pre-clearing, through which an issuer can determine whether the payment transaction should be authorised or not. The authorisation of the payment transaction, at the issuer, may be determined through conventional procedures, which may involve the verification of one or more details of the payment transaction, such as coordinates of the bank accounts involved in the transaction, fund availability, location, date and time of the payment and more. Advantageously, this step allows for enhanced security. For example, the issuer may, through this step, verify that the customer's bank account, involved in the transaction, is a legitimate bank account, and/or that the payment card used at the merchant is a legitimate payment card, and/or that said payment card has not been stolen. Another advantage of the authorisation step is that the processing of the payment transaction is made more reliable. For example, the issuer may be able to verify, through this step, that the customer's bank account involved in the transaction has sufficient funds to complete the transaction, and/or can verify that the payment card has not expired, and/or that the PIN number of the payment card is correct. The issuer can base the decision whether to authorise the payment transaction or not on one or more combinations of the criteria above and/or other similar criteria, which are typically taken into account during payment transaction authorisation processes.

The generation and routing, from the acquirer to the issuer, of the authorisation request message via an authorisation server that is independent of the clearing server may further provide enhanced security and efficiency. For instance, if the clearing server is subject to a cyber-security attack, the authorisation server would not be necessarily subject to the same cyber-security attack, and might, therefore, still provide a safe channel to exchange messages between the acquirer and the issuer, regarding the authorisation of the payment transaction. Furthermore, efficiency may be enhanced because the authorisation server removes the need to route the authorisation request messages through the clearing server, which can therefore have more capacity to receive clearing request messages and transmit clearing request response messages.

In some arrangements, prior to the receiving step, the method comprises receiving, at the clearing server, from the acquirer, an authorisation request message, the authorisation request message comprising a request to authorise the payment transaction, transmitting, from the clearing server, to the issuer, the authorisation request message, receiving, at the clearing server, from the issuer, an authorisation request message response generated by the issuer, the authorisation request response message comprising a confirmation that the payment transaction is authorised by the issuer.

In this way, the generation and routing, from the acquirer to the issuer, of the authorisation request message, occurs through the clearing server. This arrangement may provide for a simpler method, which relies on only one server (i.e., the clearing server) to handle different types of messages.

In some arrangements, the receiving step further comprises receiving, at the clearing server from the acquirer, an authorisation request message, the authorisation request message comprising a request to authorise the payment transaction. In some examples, after the receiving step and prior to the processing step, the method further comprises the steps of: transmitting, from the clearing server to the issuer, the authorisation request message, and receiving, at the clearing server from the issuer, an authorisation request response message, the authorisation request response message having being generated by the issuer and comprising a confirmation that the payment transaction is authorised by the issuer and sending, from the clearing server to the acquirer, the authorisation request response message.

Receiving the authorisation request message and the clearing request message at the same clearing server may be advantageous in some circumstances. For instance, this arrangement may provide for a simpler method, which relies on only one server (i.e., the clearing server) to handle different types of messages (i.e., to route and/or receive authorisation request messages and clearing request messages).

Advantageously, the clearing process can be efficiently streamlined, by receiving in one step, at the clearing server, the authorisation request message and the clearing request message for the payment transaction. In other words, the authorisation request message, to request to authorise the payment transaction, and the clearing request message, to request to process the clearing, are received at the clearing server simultaneously. The clearing server will therefore transmit the authorisation request message to the issuer, so that the issuer can provide an authorisation request response message, prior to the clearing server starting to process the clearing.

In some alternative arrangements, the authorisation request response message may comprise an indicator, the indicator indicating that the payment transaction is not authorised by the issuer. In some examples, the issuer may prevent the clearing server from processing or at least starting to process a clearing for a transaction that is not authorised by the issuer. This provides an optimal use of computational resources, whilst maintaining an authorisation of the payment transaction.

In some arrangements, the clearing request message received at the clearing server may comprise the authorisation request message.

In this way, the acquirer can send, to the clearing server, the authorisation request message and the clearing request message as part of one single message, rather than through the transmittal of two separate messages. Advantageously, the clearing server can receive the authorisation request message and the clearing request message simultaneously. This can help reduce the network resources required.

In some arrangements, the clearing request response message sent from the clearing server to the acquirer may comprise the authorisation request response message.

In this way, the acquirer is efficiently and promptly updated regarding the authorisation and the outcome of the clearing process, through one single message. This further allows a better use of computational resources and enhanced efficiency, because the clearing server does not need to send two separate messages to the acquirer, in order to update the acquirer regarding the authorisation of the payment transaction and the outcome of the clearing process.

In some arrangements, the outcome of the processing step may be that the clearing process of the payment transaction is successful. In some arrangements, the clearing request response message may comprise the indicator indicating that the clearing process has been successful. In some arrangements, the indicator may comprise instructions for the acquirer to proceed with the completion of the payment transaction.

In this way, the acquirer will receive an update in real-time regarding the success of a clearing process for a payment transaction. The real-time update may be provided by the indicator of the clearing request response message, the indicator indicating that the clearing process has been successfully completed.

In some arrangements, the action taken by the acquirer is to proceed with the completion of the payment transaction. In some arrangements, the action taken by the acquirer, based on the clearing request response message, is to proceed with the settlement of the payment transaction. This may be taken in response to the indicator comprised in the clearing request response message indicating that the clearing process has been successful.

In some arrangements, the acquirer can promptly take action, following the real-time update, and liaise with the merchant to complete the transaction with the cardholder. In this way, the payment transaction may be completed in a much quicker timescale than conventional transactions that require waiting for a reconciliation report. Completing the transaction may mean that funds are transferred from a bank account of the cardholder, registered with the acquirer, to a bank account, registered with the issuer, of a recipient of the payment transaction.

In some arrangements, an outcome of the processing step is that the clearing process of the payment transaction is unsuccessful.

In some arrangements, the clearing status indicator further comprises an error indicator message, the error indicator message being indicative of a reason for the clearing process being unsuccessful.

In this way, the acquirer can determine which action to take, based on the error indicator message, and more specifically based on the reason indicated for the clearing process being unsuccessful.

In some arrangements, the reason for the clearing process being unsuccessful may be that data included within the clearing request message is either corrupt or incompatible with the clearing server. For example, a reason for the clearing process being unsuccessful may be that encoding of the clearing request message is incompatible with the clearing server. In some other arrangements, the reason for the clearing process being unsuccessful may be that the bitmap of the clearing request message is unsupported by the clearing server. In some other arrangements, the reason for the clearing process being unsuccessful may be that the clearing server has failed to send a clearing request response message within a pre-determined timeline. In some examples, the clearing process may be unsuccessful because the data (or some of the data) included within the clearing request message is incorrect. For instance, the acquirer may provide, within the clearing request message, one or more of the following: an incorrect interchange rate designator (i.e., an identifier corresponding to an interchange rate applicable to the payment transaction based on characteristics of the payment transaction), an incorrect processing code (i.e., a code specifying the bank, currency and merchant account that will be used to process the payment transaction), an incorrect business service arrangement, an incorrect acceptance brand ID code (i.e., an identifier unique to a specific payment transaction origin point), an incorrect message reason code (i.e., an identifier of a reason for the payment transaction).

Depending on the reason for the clearing process being unsuccessful, the action taken by the acquirer may change. For example, if the reason is an error in the clearing request message, such as an encoding of the message that is incompatible with the clearing server, or a bitmap that is unsupported by the clearing server, the acquirer may be able to generate and transmit to the clearing server a new clearing request message with either the correct encoding or a supported bitmap. If the cause of the clearing being unsuccessful is a failure, at the clearing server, to send a clearing request response message to the acquirer within a pre-determined timeline, the acquirer may send a second clearing request response message.

The clearing may be unsuccessful even if the payment transaction has been authorised by the issuer. This may happen if the details of the payment transaction requested are correct, but the clearing request message is in a format which is unsupported by the clearing server. In some examples, the clearing may be unsuccessful because the clearing server fails to validate the clearing request message.

Advantageously, the error indicator message is included in the clearing request response message, which also comprises an acknowledgment of the clearing request message. In this way, the error indicator message provides a real-time update, to the acquirer, regarding the reason why the clearing process has not been successful. In this way, the acquirer can promptly take action, in order to rectify the error and ensure that clearing for the payment transaction can be successfully completed as soon as possible.

In some arrangements, the clearing request response message further comprises additional payment transaction data. The additional payment transaction data may comprise an indication of one or more of: invalid merchant, invalid issuer, invalid acquirer, an invalid amount of funds to be transferred in the payment transaction, a lost or stolen payment card associated with the payment transaction, an expiration of the payment card, an invalid PIN number of the payment card, insufficient funds.

In some examples, the additional payment transaction data may be indicative of a reason why the payment transaction has not been authorised by the issuer. In some examples, the additional payment transaction data may be indicative of a reason why the payment transaction has been authorised by the issuer, but subject to the fulfilment of further conditions such as further verification steps and/or correction steps. For instance, the additional payment transaction data may comprise an indicator that the funds to be exchanged in the payment transaction needs correcting. Another example may be that the payment transaction is authorised pending an additional multi-factor authentication step of the customer. The additional payment transaction data may provide further information which can help the acquirer to take further action, in response to a payment transaction not being authorised or being authorised pending further conditions. In some arrangements, the additional payment transaction data may indicate the action that the acquirer should take, upon receipt of the clearing request response message. For example, the action taken by the acquirer, based on the clearing request response message, may be a submission of a second authorisation request message, with corrected entries, as indicated by the additional payment transaction data.

In some arrangements, the additional payment transaction data may comprise an indication of a full authorisation of the payment transaction, from the issuer, and successful processing, at the clearing server, of the clearing of the payment transaction. A full authorisation of a payment transaction may be defined as an authorisation of the payment transaction without further instructions for the acquirer nor any other entity involved in the payment transaction.

In some alternative examples, the additional payment transaction data may comprise an indication of a partial authorisation of the payment transaction, from the issuer, and a successful processing, at the clearing server, of the clearing of the payment transaction. In this case, the partial authorisation may be defined as an authorisation of the payment transaction subject to the fulfilment of additional conditions and/or implementation of further steps (such as further verification steps, or a correction of one or more entries of the authorisation request message).

In this way, the acquirer can receive detailed information regarding the reason why a clearing process for a payment transaction has been successful or not. This will further contribute to the acquirer taking prompt and accurate action, based on the clearing request response message.

In some arrangements, the method further comprises the step of generating, at the clearing server, a reconciliation report comprising information regarding the clearing process. In some arrangements, the method may further comprise the step of transmitting, from the clearing server to the acquirer, the reconciliation report. In some arrangements, the method may further comprise the step of transmitting, from the clearing server to the issuer, the reconciliation report. In this way, a reconciliation report may be provided to regulatory agencies or other institutions which require it. Additionally, some payment systems, such as legacy payment systems, may still require reconciliation reports to be sent. This enables the above method to be applicable for use in such systems which may be a mix of both real time clearing and conventional clearing processes.

According to a further aspect of the invention, there is provided a clearing server for providing an update regarding a clearing status of a payment transaction, the clearing server being configured to perform the following steps: receiving, at a clearing server, from an acquirer, a clearing request message, wherein the clearing request message comprises a request to initiate clearing of the payment transaction between the acquirer and an issuer, processing, at the clearing server, the clearing of the payment transaction in response to receiving the clearing request message, generating, at the clearing server, a clearing request response message, wherein the clearing request response message comprises an acknowledgment of the clearing request message and a clearing status indicator, the clearing status indicator comprising an indication of a status of the clearing as a result of an outcome of the processing step, transmitting, from the clearing server to the acquirer, the clearing request response message, such that the acquirer can take action based on the clearing request response message.

According to a further aspect of the invention, there is provided a clearing server for providing an update regarding a clearing status of a payment transaction, the clearing server being configured to perform any of the method steps discussed herein.

According to a further aspect of the invention, there is provided a non-transitory computer-readable medium comprising instructions which, when executed by a computer, cause the computer to: receive, at a clearing server, from an acquirer, a clearing request message, wherein the clearing request message comprises a request to initiate clearing of the payment transaction between the acquirer and an issuer, process, at the clearing server, the clearing of the payment transaction in response to receiving the clearing request message, generate, at the clearing server, a clearing request response message, wherein the clearing request response message comprises an acknowledgment of the clearing request message and a clearing status indicator, the clearing status indicator comprising an indication of a status of the clearing as a result of an outcome of the processing step, transmit, from the clearing server to the acquirer, the clearing request response message, such that the acquirer can take action based on the clearing request response message.

The non-transitory computer-readable medium may comprise instructions which, when executed by a computer, cause the computer to perform any of the above-mentioned method steps according to the above aspects of the invention.

According to a further aspect of the invention, there is provided a computer program product comprising instructions which, when executed by a computer, cause the computer to: receive, at a clearing server, from an acquirer, a clearing request message, wherein the clearing request message comprises a request to initiate clearing of the payment transaction between the acquirer and an issuer, process, at the clearing server, the clearing of the payment transaction in response to receiving the clearing request message, generate, at the clearing server, a clearing request response message, wherein the clearing request response message comprises an acknowledgment of the clearing request message and a clearing status indicator, the clearing status indicator comprising an indication of a status of the clearing as a result of an outcome of the processing step, transmit, from the clearing server to the acquirer, the clearing request response message, such that the acquirer can take action based on the clearing request response message.

The computer program product may comprise instructions which, when executed by a computer, cause the computer to perform any of the above-mentioned method steps according to the above aspects of the invention.

According to a further aspect of the invention, there is provided a computer-implemented method for providing an update regarding a clearing status of a payment transaction, the method comprising: sending, from an acquirer to a clearing server, a clearing request message, wherein the clearing request message comprises a request to initiate, at the clearing server, clearing of the payment transaction between the acquirer and an issuer, and receiving, at the acquirer from the clearing server, a clearing request response message, such that the acquirer can take action based on the clearing request response message, wherein the clearing request response message is generated at the clearing server, following processing, at the clearing server, the clearing of the payment transaction in response to receiving the clearing request message, and wherein the clearing request response message comprises an acknowledgment of the clearing request message and a clearing status indicator, the clearing status indicator comprising an indication of a status of the clearing as a result of an outcome of the processing step.

According to an aspect of the invention, there is provided an acquirer for receiving an update regarding a clearing status of a payment transaction, the acquirer configured to: send, to a clearing server, a clearing request message, wherein the clearing request message comprises a request to initiate, at the clearing server, clearing of the payment transaction between the acquirer and an issuer, and receive, from the clearing server, a clearing request response message, such that the acquirer can take action based on the clearing request response message, wherein the clearing request response message is generated at the clearing server, following processing, at the clearing server, the clearing of the payment transaction in response to receiving the clearing request message, and wherein the clearing request response message comprises an acknowledgment of the clearing request message and a clearing status indicator, the clearing status indicator comprising an indication of a status of the clearing as a result of an outcome of the processing step.

### DESCRIPTION OF FIGURES

The present invention is described below, by way of example only, with reference to the accompanying drawings, in which:

FIG. 1 shows a schematic block diagram of a system comprising a clearing server, for providing real time clearing updates for payment transactions to an acquirer;

FIG. 2 shows a schematic block diagram of a system comprising a clearing server for providing real time clearing updates for payment transactions to an acquirer and an authorisation server;

FIG. 3 shows a schematic message flow diagram of a method for providing real time clearing updates to an acquirer, implemented through the system of FIG. 1, in which the acquirer is informed of a success of a clearing process of a payment transaction;

FIG. 4 shows a schematic message flow diagram of a method for providing real time clearing updates to an acquirer, implemented through the system of FIG. 2, in which the acquirer is informed of a success of a clearing process of a payment transaction;

FIG. 5 shows a schematic message flow diagram of a method for providing real time clearing updates to an acquirer, implemented through the system of FIG. 2, in which the acquirer is informed of a failure of a clearing process of a payment transaction;

FIG. 6 shows a schematic message flow diagram of a method for providing real time clearing updates to an acquirer, implemented through the system of FIG. 1, in which the acquirer is informed of a success of a clearing process of a payment transaction;

FIG. 7 shows a schematic message flow diagram of a method for providing real time clearing updates to an acquirer, implemented through the system of FIG. 1, in which the acquirer is informed of a failure of a clearing process of a payment transaction;

FIG. 8 shows a flow diagram of a computer-implemented method for providing real time clearing updates to an acquirer, performed by a clearing server, such as that shown in FIG. 1;

FIG. 9 shows a flow diagram of a computer-implemented method for receiving real time clearing updates, at an acquirer of a system such as that shown in FIG. 1; and

FIG. 10 shows a data processing device for executing instructions to perform any step of the methods illustrated in FIGS. 3 to 9.

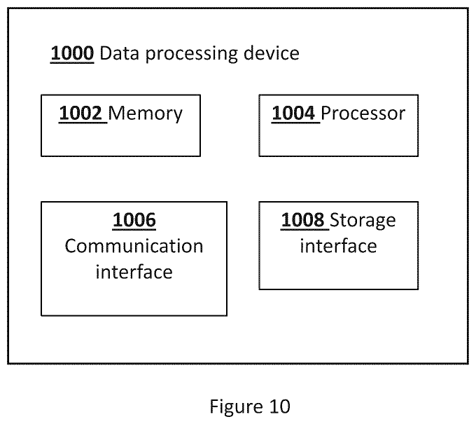

### DETAILED DESCRIPTION

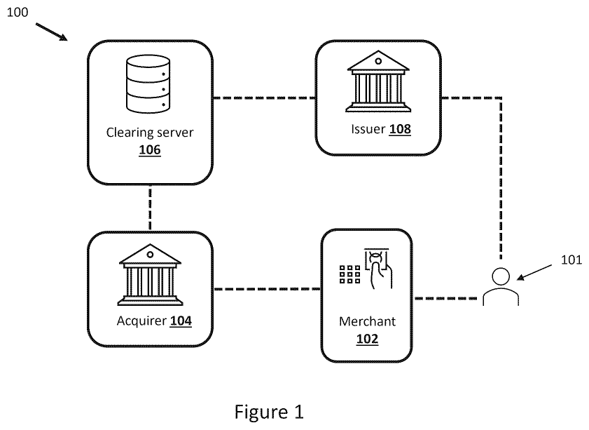

FIG. 1 shows a schematic block diagram of a system 100 for providing real time clearing updates to an acquirer regarding clearing of payment transactions. The system 100 is capable of performing the methods as disclosed herein. The system 100 comprises a merchant 102. The merchant 102 is an entity that engages in a payment transactions with a customer 101. For example, a merchant 102 may provide, to the customer 101, goods and/or services, in exchange for a payment, from the customer 101, of a certain amount of a determined currency (i.e., a payment transaction). The system 100 further comprises an acquirer 104. The acquirer 104 may be a bank or other financial institution. The system 100 further comprises an issuer 108. The merchant 102 is associated with the acquirer 104. The merchant 102 may have a bank account registered with the acquirer 104. The customer 101 is associated with the issuer 108. The customer 101 may have a bank account (not shown) registered with the issuer 108. The bank account may be a card account. This may be a credit or debit card account. The issuer 108 and the acquirer 104 may be able to exchange funds that are then distributed to, respectively, the bank account of the merchant 102 and the bank account of the customer 101.

The system 100 comprises a clearing server 106. The clearing server 106 is in communication with (i.e. connected to) the acquirer 104. The clearing server 106 is in communication with (i.e. connected to) the issuer 108. The clearing server 106 is configured to receive messages from the acquirer 104 and to send messages to the acquirer 104. The clearing server 106 is configured to receive messages from the issuer 108 and to send messages to the issuer 108, the messages being related to the clearing of a payment transaction between the merchant 102 and the customer 101. The clearing server 106 is a server that oversees the clearing of payment transactions between the issuer 108 and the acquirer 104, by communicating with the acquirer 104 and the issuer 108. More specifically, the clearing server 106 provides real-time updates to the acquirer 104 regarding the status of a clearing process, so that the acquirer 104 can promptly take action in response to said updates. The clearing server 106 may further provide real-time updates regarding an authorisation, from the issuer 108, of the payment transaction. The clearing server 106 may be associated with a payment network (not shown) of a payment provider. For example, the clearing server 106 may be associated with (but not limited to) a Mastercard® payment network. The payment network provider is a third party entity which owns and provides the payment network to customers such as customer 101. An example of payment network provider is Mastercard®. The payment network may therefore have exclusive access to the clearing server 106, meaning that the clearing server 106 does not receive nor transmits messages from/to any other payment network provider.

Preferably, the communication between the clearing server 106 and the acquirer 104, so as the communication between the clearing server 106 and the issuer 108, may be over a TCP/IP-ISO 8583 communication protocol. Alternatively, said communication may be via any commercially available communication networks, such as a wired or wireless network. For instance, this may include any of wired network, Wi-Fi network, a 4G network, or a 5G network.

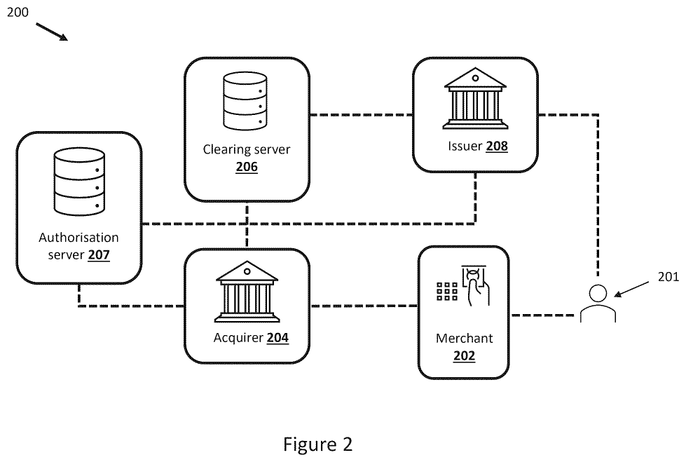

FIG. 2 shows a schematic block diagram of a system 200, for providing real time clearing updates regarding clearing of payment transactions to an acquirer. The system 200 is similar to the system 100, in that it comprises a merchant 202, and a customer 201. The system 200 further comprises an acquirer 204 and an issuer 208, with the acquirer 204 being associated with the merchant 202 and the issuer 208 associated with the customer 201. The system 200 further comprises a clearing server 206, which is in communication with both the acquirer 204 and the issuer 208, and that is configured to exchange messages regarding payment transactions with the acquirer 204 and the issuer 208.

The system 200 further comprises an authorisation server 207. The authorisation server 207 is, in this example, a separate server to the clearing server 206. Advantageously, in this way, two independent servers (respectively, the authorisation server 207 and the clearing server 206) can be used for processing, respectively, messages regarding the authorisation of a payment transaction and the messages regarding the clearing of a payment transaction. As the clearing server 206, the authorisation server 207 is also connected to the acquirer 204 and the issuer 208. The authorisation server 207, receives from the acquirer 204, authorisation request messages to authorise payment transactions between the customer 201 and the merchant 202.

In alternative examples, the authorisation server 207 is part of the clearing server 206 (as shown in FIG. 1). The authorisation server 207 and the clearing server 206 may be a single server. Advantageously, having a single server handling the authorisations of payment transactions and the requests for clearing of payment transactions may reduce the complexity of the system.

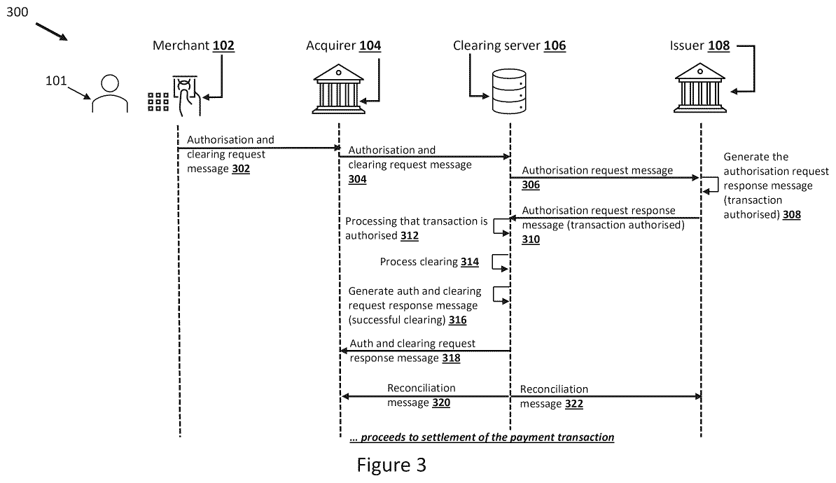

FIG. 3 is a message flow diagram showing a method 300 for providing, through a clearing server 106, real time updates regarding clearing of a payment transaction between a merchant 102 and a customer 101, using the system 100 as shown in FIG. 1.

A merchant 102 may initiate a payment transaction with a customer 101. For instance, the customer 101 may offer to pay a determined amount of currency, in exchange for the merchant's goods and/or services. The customer 101 is associated with the issuer 108, because the customer 101 has a bank account with the issuer 108 (not shown). The merchant 102 is associated with the acquirer 104, because the merchant 102 has a bank account with the acquirer 104 (not shown).

Initially, the merchant 102 sends 302 an authorisation and clearing request message to the acquirer 104. The authorisation and clearing request message comprises an authorisation request and a clearing request, so that the authorisation and clearing request message is configured to request both authorisation and clearing of the payment transaction in a single message. The authorisation and clearing request message may be considered as a clearing request message comprising an authorisation request message. The authorisation request in the authorisation and clearing request message contains a request to authorise the payment transaction between the merchant 102 and the customer 101. More specifically, the authorisation request contains a request to authorise, at the issuer 108, the payment transaction between the acquirer 104 and the issuer 108. The authorisation request may comprise information regarding the payment transaction, such as bank account details of the customer's and the merchant's bank accounts, respectively registered with the issuer 108 and the acquirer 104, and/or details regarding a payment card used by the customer 101 for the payment transaction, and/or information related to the date and time of the transaction, the location of the transaction and/or other information that may be relevant for the issuer 108, when deciding whether to authorise the transaction or not. The clearing request in the authorisation and clearing request message comprises a request to initiate clearing of the payment transaction, once the payment transaction has been authorised by the issuer 108. After receiving the authorisation and clearing request message from the merchant 102, the acquirer 104 sends 304 the authorisation and clearing request message to the clearing server 106. Thus, also the authorisation request, which is part of the authorisation and clearing request message, is sent to the clearing server 106. By sending 304 the authorisation request and the clearing request in a single message (authorisation and clearing request message), the clearing process can proceed quicker as the acquirer 104 does not need to wait until after approval of authorisation is received before sending the clearing request 304 as would happen in conventional payment processes.

The authorisation request of the authorisation and clearing request message may contain one or more indicators of the following: details of a transaction amount of the initiated payment transaction, a currency of the payment transaction, a date and a time of initiation of the payment transaction at the merchant 102, a merchant type (i.e., a business, a company etc.), details regarding a payment card of the customer 101 (e.g., a PAN of the payment card), transaction fees, acquiring institution ID code, issuing (or forwarding) institution ID code, a category code for the payment transaction, and more. In this way, the issuer 108 decides (see below) whether to authorise the payment transaction or not based on one or more of these indicators.

The clearing server 106 receives the authorisation and clearing request message from the acquirer 104. The clearing server 106 then transmits 306 the authorisation request, part of the authorisation and clearing request message, to the issuer 108 as an authorisation request message. The issuer 108 is configured to process the authorisation request message and to determine whether the payment transaction should be authorised. In other words, the issuer 108 is configured to determine whether the payment transaction, that involves a transfer of funds from a bank account of the customer 101 registered with the issuer 108 to a bank account of the merchant 102 registered with the acquirer 104, should be authorised. A decision of the issuer 108 to authorise or not authorise the payment transaction may be based on the indicators contained in the authorisation request message received by the issuer 108. For example, if an indicator of the authorisation request message contains the coordinates of the customer's bank account, the issuer 108 may be able to verify, through said indicator, that the customer's bank account involved in the transaction has sufficient funds to complete the transaction. In another example, an indicator of the authorisation request message may comprise the details of the payment card used by the customer 101 in the payment transaction (which may include a PIN number for the payment card). In this case, based on this indicator, the issuer 108 can verify that the payment card has not expired, and/or that the PIN number of the payment card used by the customer 101 for the payment transaction is correct.

Once the issuer 108 has determined that the payment transaction should be authorised, the issuer 108 generates 308 an authorisation request response message, indicating that the payment transaction is authorised. The issuer 108 then transmits 310 said authorisation request response message to the clearing server 106.

The clearing server 106 processes 312 the authorisation request response message sent 310 by the issuer 108, and establishes that the payment transaction has been authorised by the issuer 108. The clearing server 106 then proceeds with processing 314 clearing of the payment transaction. Once the clearing process is successfully completed, the clearing server 106 generates 316 an authorisation and clearing request response message. The authorisation and clearing request response message comprises an acknowledgment of the authorisation and clearing request message previously sent from the acquirer 104 to the clearing server 106, in step 304. The authorisation and clearing request response message further comprises a clearing status indicator, the clearing status indicator comprising an indication of a status of the clearing, as a result of the processing step 312. In this example, the authorisation and clearing request response message contains a confirmation that the clearing process has been successfully completed, at the clearing server 106. The authorisation and clearing request response message is then sent 318 to the acquirer 104.

The authorisation and clearing request response message comprises the authorisation request response message, previously generated in step 308 by the issuer 108, and sent to the clearing server 106 in step 310. In this way, the responses to the authorisation and the clearing request are sent as part of a single message. The authorisation and clearing request response message may be defined as a clearing request response message, further comprising the authorisation request response message generated by the issuer 108.

The acquirer 104 can take action based on the clearing request response message received by the acquirer in step 318. In this example, the acquirer 104 takes no further action, and the clearing server 106 proceeds to generate the reconciliation messages that are then transmitted to the acquirer 104 and to the issuer 108 respectively in steps 320 and 322. More specifically, the clearing server 106 generates and then transmits 320 a reconciliation message to the acquirer 104. The reconciliation message sent to the acquirer 104 is a message indicating the amount that the acquirer 104 will be receiving from the issuer 108 once the payment transaction has been completed. As the clearing in FIG. 3 is real-time clearing the clearing can be completed within the time period of when an acquirer would typically receive a response to the authorisation request.

In some arrangements, the clearing server 106 generates and then transmits 322 a reconciliation message to the issuer 108. The reconciliation message sent to the issuer 108 is a message indicating the due payment amount that the issuer 108 has to send to the acquirer 104, in order to complete the payment transaction. After the reconciliation messages 320 and 322 have been sent, settlement of the payment transaction proceed to perform the exchange of funds, as indicated by the payment transaction instructions, between the issuer 108 and the acquirer 104. Reconciliation messages may be needed for legacy payment systems (an example of which is described below), but are not always necessary in the real time clearing ecosystem (i.e., the system where real time clearing updates are provided through the clearing server 106 discussed above), where the clearing server 106 is returning, to the acquirer 104, the results of clearing processes through clearing request response messages. In some alternative examples, steps 320 and 322 may be omitted.

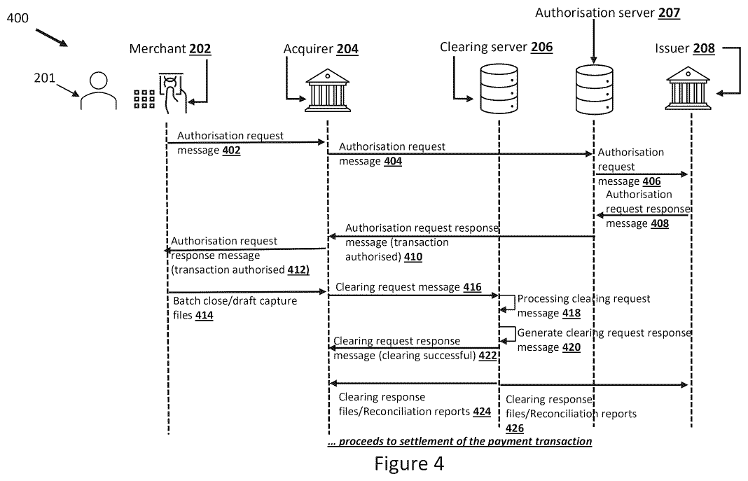

FIG. 4 is a message flow diagram showing a method 400 for providing, through a clearing server 206, real time updates regarding clearing of a payment transaction between a merchant 202 and a customer 201, using the system 200 as shown in FIG. 2.

A merchant 202 may initiate a payment transaction with a customer 201, as described for the method 300 of FIG. 3 above.

Following the initiation of the payment transaction, the merchant 202 generates and transmits 402 an authorisation request message. The authorisation request message comprises a request to authorise the payment transaction. Then, the acquirer 204 sends (or re-routes) 404 the authorisation request message (that was transmitted to the acquirer 204 in step 402) to the authorisation server 207.

The authorisation server 207 sends (or re-routes) 406 the authorisation request message to the issuer 208. The issuer 208 processes the authorisation request message and determines whether the payment transaction should or should not be authorised, similar to what has been previously discussed. In this example, the issuer 208 determines, based on the authorisation request message, that the payment transaction should be authorised, and that clearing should proceed.

The issuer 208 then produces and transmits 408 to the authorisation server 207 an authorisation request response message. The authorisation request response message comprises an indicator indicating that the issuer 208 has authorised the payment transaction, and that clearing of the payment transaction should proceed. The authorisation request response message is then sent 410 from the authorisation server 207 to the acquirer 204. The acquirer 204 then sends (or re-routes) 412 the authorisation request response message to the merchant 202.

The merchant 202 transmits 414 a batch list (i.e., a list of payments that need to be processed at a certain point in time by the payment network provider associated with the clearing server 206), wherein the batch list includes the payment transaction, and other payment transactions involving the same acquirer 204. In step 414, the merchant 202 further sends a draft capture (i.e., recorded authorisation of the payment transaction) to the acquirer 204.

Following the authorisation of the payment transaction from the issuer 208, the acquirer 204 generates and then sends 416 a clearing request message to the clearing server 206. The clearing server 206 processes 418 the clearing request message, and then generates 420 a clearing request response message. The clearing request response message comprises an acknowledgment of the clearing request message, which was received at the clearing server 206, and a clearing status indicator. The clearing status indicator comprises an indication of a status of the clearing as a result of an outcome of the processing step. In this example, the clearing request response message 420 contains a confirmation that the clearing process has been successfully completed. In this way, the system 200 provides real-time clearing of payments, because the acquirer 204 is provided with the indication of the status of the clearing, resulting from the processing step, as quickly as is provided with an acknowledgment of receipt of the clearing request message. In this way, the acquirer 204 receives the update on the outcome of the clearing process in real-time.

The clearing request response message is then transmitted 422 from the clearing server 206 to the acquirer 204. The acquirer 204 can then take action based on the clearing request response message.

In this example, the acquirer 204 takes no further action, and the clearing server 206 proceeds to generate the reconciliation messages that are sent to the acquirer 204 and the issuer 208, respectively in steps 424 and 426. More specifically, the clearing server 206 generates and then transmits 424 a clearing response and a reconciliation message to the acquirer 204. The clearing server 206 generates and then transmits 426 a clearing response and a reconciliation message to the issuer 208. Reconciliation messages may be needed for legacy payment systems (described below), but are not always necessary. The reconciliation message 426 sent to the issuer 208 may include details of individual payment transactions. Information regarding rejected payment transactions are never sent in the reconciliation message transmitted to the issuer 208. The reconciliation message 424 sent to the acquirer 204 preferably includes a summary of payment transactions. In some alternative examples, steps 424 and 426 may be omitted.

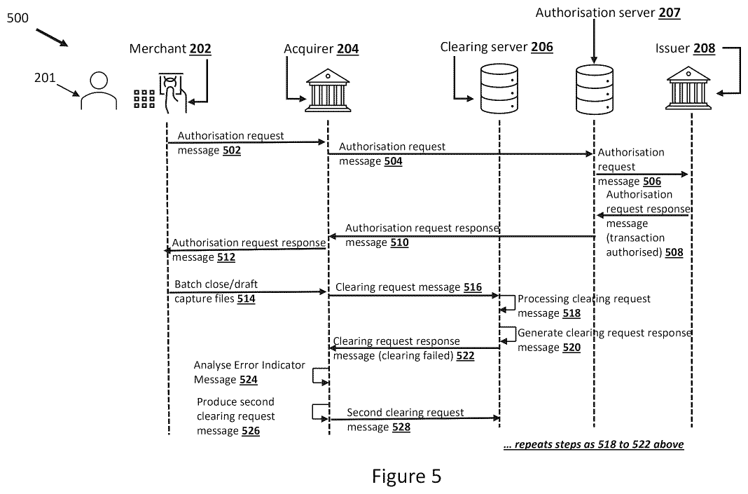

FIG. 5 is a message flow diagram showing a method 500 for providing, through a clearing server 206, real time updates regarding clearing of a payment transaction between a merchant 202 and a customer 201, using the system 200 as shown in FIG. 2.

The steps 502 to 518 are essentially the same as steps 402 to 418, previously described with reference to FIG. 4, and so the above description equally applies to these steps.

However, in method 500, after receiving 516 the clearing request message from the acquirer 204, the clearing server processes 518 the clearing request message. Differently from the method 400 previously described, in this example the clearing process fails. The clearing server 206 then generates 520 a clearing request response message. The clearing request response message indicates that the clearing process has failed. In other words, the clearing request response message, generated in step 520, indicates that the clearing process has been unsuccessful. The clearing request response message contains an acknowledgment of receipt of the clearing request message from the acquirer, and further contains a clearing status indicator. The clearing status indicator indicates that the clearing has been unsuccessful. In this example, the clearing status indicator comprises an error indicator message. The error indicator message is indicative of a reason for the clearing process being unsuccessful. There may be one or more reasons for the failure of the clearing process. In this way, the acquirer 204 can take action, based on the error indicator message.

The acquirer 204 analyses 524 the error indicator message. The analysis has the aim of determining whether the acquirer can take action (and, if so, which action) based on the content of the error indicator message. The error indicator message indicates the reason why the clearing process has failed, at the clearing server 206. There may be several reasons why the clearing process has failed.

The failure of the clearing process may generally be due to a lack of compatibility between the format of the clearing request message and the format of messages that the clearing server 206 is configured to process. For example, the clearing may have been unsuccessful because the encoding of the clearing request message is incompatible with the clearing server 206. The reason may be that a bitmap of the clearing request message is unsupported by the clearing server 206. A combination of the two reasons above and/or other similar message format-related reasons may cause the failure of the clearing process. By indicating the reason in the error indicator message, the clearing server 206 timely informs the acquirer 204 that the clearing cannot proceed (and therefore the payment transaction cannot be completed) until a clearing request message in the correct format (i.e., a format which is supported by the clearing server 206) is received at the clearing server 206.

Furthermore, or alternatively, the clearing process may fail due to the clearing server failing to send a clearing request response message back to the acquirer within a pre-determined period of time (or timeline). It may be that the clearing server 206 has experienced delays due to a high network traffic, or because of an interruption of the communication channel between the clearing server 206 and the acquirer 204 (and/or the issuer 208). The clearing server 206 may therefore interrupt the clearing process and inform the acquirer 208 that the clearing has failed because of excessive delay, and may further include an indication of the cause of the delay. A reason for the delay might be a wrong format of the clearing request message.

All the reasons above, or any other combination of the reasons above and other, similar reasons for a clearing process to fail, can occur simultaneously, and be consequently indicated in the same error indicator message.

In this example, following the analysis of the error indicator message, the acquirer 204 produces 526 a second clearing request message. The second clearing request message 526 may depend on the error indicator message, and its analysis 524 at the acquirer. For example, if the reason for the clearing to fail for an unsupported format of the clearing request message (such as, a bitmap of the message that the clearing server 206 cannot process) then, the acquirer 204 can generate 526 the second clearing request message in the correct format (for example, with the correct bitmap). On the other hand, if the sole reason for the failure of the clearing process is an interruption of the communication channel between the acquirer 204 and the clearing server 206 or between the clearing server 206 and any other entity involved in the payment transaction, the second clearing request message 526 may be identical to the first clearing request message transmitted, from the acquirer 204 to the clearing server 206, in step 516. Advantageously, the acquirer 204 can promptly take action, based on the error indicator message, which can overcome the issue or issues that prevented the clearing from being completed.

The acquirer 204 then transmits the second clearing request message 528 to the clearing server 206. After this, the steps of method 500 will be repeated for the second clearing request message, from the processing of the second clearing request message to the generation, at the clearing server 206, of a second clearing request response message.

In some examples, the method steps 516 to 528 of method 500 can be repeated until the clearing request response indicates that the clearing has been successful. Alternatively, the clearing server 206 may be programmed to reject any duplicate messages. Alternatively, the clearing server 206 may be programmed to reject further clearing request for the same payment transaction, after a pre-determined number of failed attempts. In some cases, the clearing server 206 may refuse to receive a further clearing request message, from a particular acquirer and/or for a particular payment transaction. For example, if the clearing server 206 determines, based on the clearing request message, that the payment transaction is fraudulent, or may be fraudulent, then the clearing server 206 may be programmed to block further clearing request messages from the acquirer 204. In some examples, the acquirer 204 and/or the merchant 202 and/or the particular customer 201 may be black-listed by the clearing server 206.

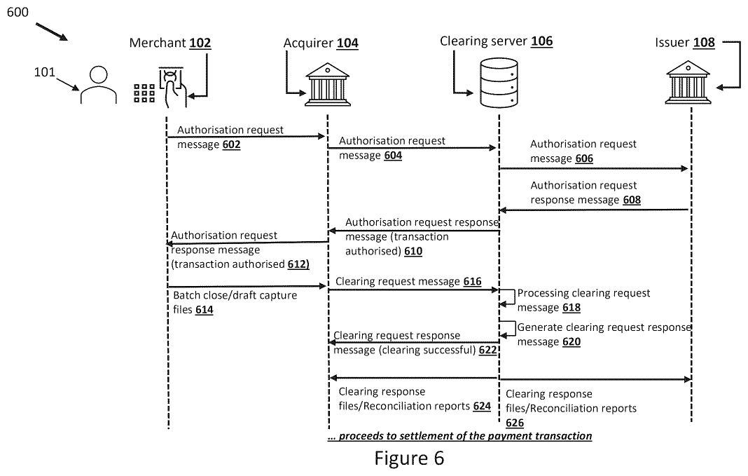

FIG. 6 is a message flow diagram showing a method 600 for providing, through a clearing server 106, real time updates regarding clearing of a payment transaction between a merchant 102 and a customer 101, using the system 100 as shown in FIG. 1.

The steps 602 and 612 to 626 are essentially the same as steps 402 and 412 to 426, previously described with reference to FIG. 4, and so the above description equally applies to these steps.

However, method 600 differs from method 500 in that the acquirer 104 sends 604 an authorisation request message to the clearing server 106, and not to an authorisation server such as authorisation server 207 of system 200. In this method 600 the clearing server 106 then sends 606 the authorisation request message to the issuer 108, which then generates and transmits 608 to the clearing server 106 an authorisation request response message, indicating that the payment transaction has been authorised by the issuer 108. The clearing server 106 then sends 610 the authorisation request response message to the acquirer 104.

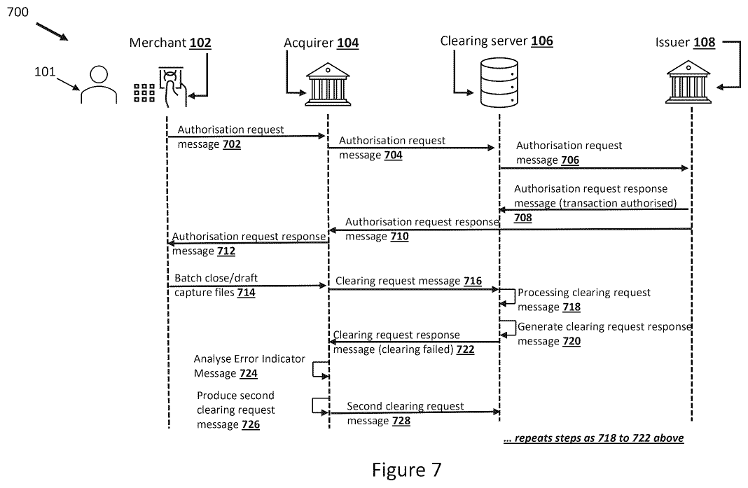

FIG. 7 is a message flow diagram showing a method 700 for providing, through a clearing server 106, real time updates regarding clearing of a payment transaction between a merchant 102 and a customer 101, using the system 100 as shown in FIG. 1.

The steps 702 and 712 to 728 are essentially the same as steps 502 and 512 to 528 previously described with reference to FIG. 5, and so the above description equally applies to these steps.

However, method 700 is different in that the acquirer 104 sends 704 an authorisation request message to the clearing server 106, instead of an authorisation server such as authorisation server 207. In this method 700 the clearing server 106 then sends 706 the authorisation request message to the issuer 108, which then generates and transmits 708 to the clearing server 106 an authorisation request response message, indicating that the payment transaction has been authorised by the issuer 108.

The clearing request response message of the methods illustrated in FIGS. 3 to 7 may further comprise additional payment transaction data. The additional payment transaction data may be provided to the acquirer, in order to provide comprehensive details regarding the reason(s) why the issuer has not authorised the payment transaction. The additional payment transaction data may comprise an indication of one or more of: an invalid merchant, an invalid issuer, and/or an invalid acquirer. For example, a merchant may be deemed invalid if the coordinates provided for the merchant's bank account with the acquirer is not found. This may be caused by several reasons, e.g., an error made by the merchant whilst inputting the bank account details, or could be an indication that the bank account has been introduced by a nefarious actor, which pretends to be the merchant in order to receive the funds. In some examples, the additional payment transaction data may comprise an indication of an invalid amount of funds to be transferred in the payment transaction. In this way, a new authorisation request message with the correct transaction amount can be generated by the acquirer and sent to the issuer through either the clearing server or the authorisation server. In some examples, the additional payment transaction data may comprise an indication of an invalid amount of funds to be transferred in the payment transaction. In some examples, the additional payment transaction data may comprise an indication of a lost or stolen payment card associated with the payment transaction. In some examples, the additional payment transaction data may comprise an indication of an expiration of the payment card occurred in the past with respect to when the clearing request has been submitted. In some examples, the additional payment transaction data may comprise an indication of an invalid PIN number of the payment card, and/or insufficient funds in the customer's bank account. In some examples, the additional payment transaction data may comprise an indication of full authorisation from the issuer, of the payment transaction. Alternatively, the additional payment transaction data may comprise an indication of partial authorisation, from the issuer, of the payment transaction.

Table 1 below illustrates the message elements and corresponding indicators comprised within the authorisation and clearing request message generated in step 302 of method 300, illustrated in FIG. 3.

TABLE 1

| Message elements | Indicators |
|---|---|
| Clearing request | Request to initiate clearing of a payment |
| | transaction between an acquirer and an |
| | issuer |
| Authorisation request | A request to authorise the payment |
| | transaction at the issuer. |
| | The following data regarding the payment |
| | transaction: |
| | bank account details for the customer |
| | and the merchant |
| | details regarding a payment card |
| | belonging to the customer |
| | date and time of the payment transaction |
| | location of the payment transaction |
| | transaction amount |

The clearing request messages generated in methods 400 to 700, illustrated in FIGS. 4 to 7, comprise the clearing request, but do not comprise the authorisation request illustrated in Table 1 above, because in the examples of FIGS. 4 to 7 the authorisation request is sent within a separate authorisation request message, as discussed above.

Table 2 below illustrates the message elements and corresponding indicators which may be comprised within an authorisation and clearing request response message, as the one generated through method 300 illustrated in FIG. 3, or within a clearing request response message, as the one generated through one of methods 400 to 700, illustrated in FIGS. 4 to 7 respectively.

TABLE 2

| Message elements | Indicators |
|---|---|
| Acknowledgment of | Indication of acknowledgment that the |
| clearing request | clearing request message has been |
| message | received at the clearing server, from the |
| | acquirer. |
| Clearing status | an indication that the clearing process |
| indicator | has been successful, or |
| | an indication that the clearing process |
| | has been unsuccessful. |
| | (regardless of the outcome of the |
| | clearing process) an error indicator |
| | message. If the clearing process has been |
| | successful, the error indicator message |
| | will indicate that there has been no error; |
| | if the clearing process has been |
| | unsuccessful, the error indicator message |
| | will be indicative of the reason for the |
| | clearing process being unsuccessful. |
| Authorisation | indication that the payment transaction |
| request response | is authorised by the issuer; or |
| | indication that the payment transaction |
| | is not authorised by the issuer. |
| Additional | indication of one or more of: |
| payment | invalid merchant |
| transaction data | invalid issuer |
| | invalid acquirer |
| | an invalid amount of funds to be |
| | transferred in the payment transaction |
| | a lost or stolen payment card associated |
| | with the payment transaction |
| | an expiration of the payment card |
| | an invalid PIN number of the payment |
| | card |
| | insufficient funds |

In the examples illustrated in FIGS. 4 to 7, the authorisation request response will not be included in the clearing request response message, as this is sent separately, in the authorisation request response message (see steps 410, 510, 610 and 710 of, respectively, FIGS. 4, 5, 6 and 7). The additional payment transaction data can be included in all examples of FIGS. 3 to 7.

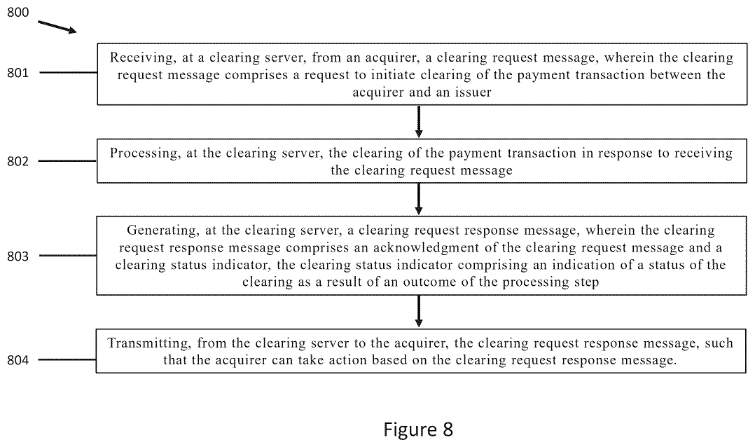

FIG. 8 shows a flow diagram of a computer-implemented method 800 for providing real time updates regarding the clearing of a payment transaction, to an acquirer. The method 800 may be implemented via the system 100 as shown in FIG. 1 or via the system 200 as shown in FIG. 2, or other systems according to the present invention.

At step 801, a clearing request message is received, from an acquirer, at a clearing server. The clearing request message comprises a request to initiate clearing of the payment transaction between the acquirer and the issuer.

At step 802, the clearing server processes the clearing of the payment transaction, in response to receiving the clearing request message.

At step 803, the clearing server generates a clearing request response message, wherein the clearing response message comprises an acknowledgment of the clearing request message and a clearing status indicator. The clearing status indicator comprises an indication of a status of the clearing, as a result of an outcome of the processing step.

At step 804, the clearing server transmits the clearing request response message to the acquirer, such that the acquirer can take action based on the clearing request response message.

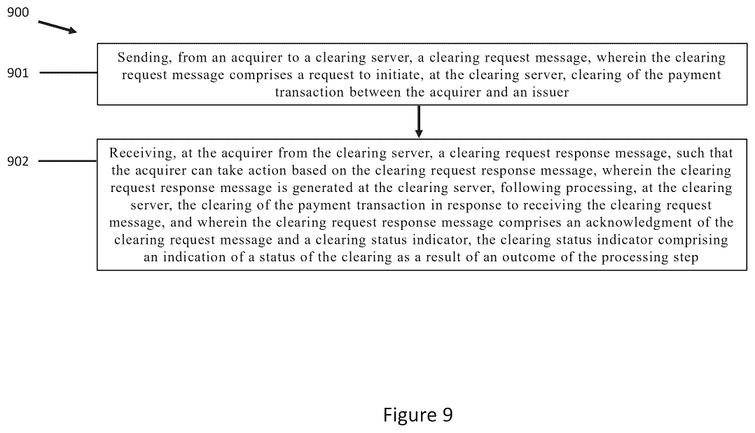

FIG. 9 shows a flow diagram of a computer-implemented method 900 for providing real time updates regarding the clearing of a payment transaction, to an acquirer. The method 900 may be implemented via the system 100 as shown in FIG. 1 or via the system 200 as shown in FIG. 2, or other systems according to the present invention.

At step 901, an acquirer sends a clearing request message to a clearing server, wherein the clearing request message comprises a request to initiate, at the clearing server, clearing of the payment transaction between the acquirer and an issuer.

At step 902, the acquirer receives from the clearing server a clearing request response message, such that the acquirer can take action based on the clearing request response message, wherein the clearing request response message is generated at the clearing server, following processing, at the clearing server, the clearing of the payment transaction in response to receiving the clearing request message, and wherein the clearing request response message comprises an acknowledgment of the clearing request message and a clearing status indicator, the clearing status indicator comprising an indication of a status of the clearing as a result of an outcome of the processing step

It will be appreciated that any of the methods described herein, and any step of the methods, can be implemented by a computer. Such implementation may take the form of a processor executing instructions stored on a non-transitory computer-readable medium or media, wherein when executed the instructions cause the processor to perform any one or more steps of any of the methods described herein. Individual steps of any method may be implemented by different processors that are all collectively acting in accordance with computer-readable instructions stored on one or more storage media. The processor(s) may be component(s) of system, for example a processor of a device.

Similarly, any steps of any of the methods described herein may be performed by data processing devices. By way of example, FIG. 8 shows in schematic form a data processing device 800 that is suitable for performing the functions of the clearing server, and/or the authorisation server, and/or the acquirer and/or the issuer of either system 100, system 200 or any other systems according to the invention. The data processing device 800 may automatically perform any of the methods described herein.

Data processing device 1000 includes a processor 1004 for executing instructions. Instructions may be stored in a memory 1002. Processor 1004 may include one or more processing units (e.g., in a multi-core configuration) for executing instructions. The instructions may be executed within a variety of different operating systems on the data processing device 1000, such as UNIX, LINUX, Microsoft Windows®, etc. More specifically, the instructions may cause various data manipulations on data stored in memory 1002 (e.g., create, read, update, and delete procedures). It should also be appreciated that upon initiation of a computer-implemented method, various instructions may be executed during initialization. Some operations may be required to perform one or more methods described herein, while other operations may be more general and/or specific to a particular programming language (e.g., C, C#, C++, Java, or other suitable programming languages, etc.).

Processor 1004 is operatively coupled to a communication interface 1006 such that data processing device 1000 can communicate with a remote device, such as another data processing device of the system. For example, communication interface 1006 may receive communications from another member of the system.

Processor 1004 may also be communicatively coupled to a storage device such as a database, depending on the function of data processing device 1000 within the context of the system. The storage device is any computer-operated hardware suitable for storing and/or retrieving data, where in the case of a secure storage medium the data is stored and retrieved securely.

The storage database may be external to data processing device 1000 and located remotely. Alternatively, it can be integrated in data processing device 1000. For example, data processing device 1000 may include memory 1002 as one or more hard disk drives acting as a storage database. Alternatively, where the storage database is external to data processing device 1000, it can comprise multiple storage units such as hard disks or solid-state disks in a redundant array of inexpensive disks (RAID) configuration. The storage database may include a storage area network (SAN) and/or a network attached storage (NAS) system.

Processor 1004 can be operatively coupled to the storage device (storage database) via a storage interface 1008. Storage interface 1008 is any component capable of providing processor 1004 with access to the storage device. Storage interface 1008 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 804 with access to the storage device.

Memory 1002 may include, but is not limited to, RAM such as dynamic RAM (DRAM) or static RAM (SRAM), ROM, erasable programmable read-only memory (EPROM), electrically erasable programmable read-only memory (EEPROM), and non-volatile RAM (NVRAM). The above memory types are exemplary only and are not limiting as to the types of memory usable for storage of a computer program.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. The methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Furthermore, as used herein, the term “non-transitory computer-readable media” includes all tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

In alternative embodiments to what has been discussed above, the clearing request message may not comprise the authorisation request message and may further be transmitted, from the acquirer to the clearing server, before the acquirer transmits the authorisation request message to the clearing server.

Although it has been shown in FIG. 3 that the merchant 102 sends 302 an authorisation and clearing request message to the acquirer 104, in some alternative arrangements the merchant 102 only sends an authorisation request message to the acquirer 104. In some examples, the merchant 102 may initiate the payment transaction through the use of a Point of Sale (POS) device, with the POS device sending the authorisation message to the acquirer 104. In some alternative examples, such as for e-commerce transactions and for payment of digital goods, the merchant 102 may not be required, in order to initiate a payment transaction, to provide any further message, to the acquirer 104, beyond the authorisation message.

Although it has been shown in FIG. 3 that the clearing request message comprises the authorisation request message, the clearing server 106 can be programmed to send the clearing request and the authorisation request as two separate messages. The two messages may still be sent, from the acquirer 104 to the clearing server 106 (and/or from the merchant 102 to the acquirer 104), simultaneously, i.e., as part of a single step. Two separate messages may be processed by separate servers or entities within the acquirer 104, which might be advantageous in some circumstances. For example, the acquirer 104 may determine whether to take action only based on the clearing request response message, and not on the authorisation request response message. Thus, it may be advantageous for a processing module (not shown) of the acquirer 104 to receive and process the clearing request response message, whilst the authorisation request response message may be received by another module of the acquirer, and may not be processed by the acquirer 104 to determine which action to take. This may contribute to enhance efficiency and better streamline the clearing authorisation process, in some circumstances.

Although it has been shown in FIGS. 3 and 4, that, upon a successful clearing of the payment transaction, the acquirer 104 takes no further action based on the clearing request response message, in some other arrangements, the acquirer 104 may take action, based on the successful clearing indicated in the clearing status indicator. For example, the acquirer 104 may authorise a merchant 102 to complete the payment transaction with a cardholder. For example, the action might be to proceed with the settlement of the transaction. In some examples, the acquirer 104 may send a payment authorisation message to the merchant 102, the payment authorisation message indicating that, pending successful reconciliation and settlement, the payment will be completed.

Although it has not been shown in any of the FIGS. 1 to 9, the clearing server 106 or 206 may further include a global clearing management server. Alternatively, the clearing server 106 may be connected with a global clearing management server. The global clearing management server may send clearing response files and a reconciliation report to a global file transfer system of the payment network provider associated with, or in communication, with the clearing server 106 or 206. The global file transfer system may send said clearing response files and said reconciliation report to the acquirer 104. The clearing response files contain information regarding the outcome of the clearing process (e.g., if a transaction has been cleared and when). The reconciliation report summarises all the financial activities to and from the acquirer 104, including the payment transactions cleared through the clearing server 106 or 206. The global clearing management server and the global file transfer system may be part of a legacy payment system, i.e., a payment system which requires clearing response files. The systems illustrated in FIGS. 1 and 2 can therefore be easily integrated with the legacy systems, if desired. In this way, real-time clearing of payment transactions may still be possible without a complete replacement of a legacy payment system with a real-time clearing system.

Although it has been shown, in FIG. 4, that the method 400 is performed by a system 200 in which the authorisation server 207 and the clearing server 206 are separate, independent servers, the method 400 can be alternatively performed by a system such as the system 100, illustrated in FIG. 1. For example, the authorisation request message 404 may be received by the clearing server 106 of system 100, rather than by a separate authorisation server 207. In some examples, the authorisation server 207 is a sub-server of the clearing server 206. It is noted that none of the methods herein described is limited to one of the systems described in FIGS. 1 and 2.

As an alternative to the example illustrated in Table 1, the authorisation request of the authorisation and clearing request message generated through method 300, may comprise only some of, but not all of, the data regarding the payment transaction listed in Table 1. In alternative examples, the authorisation request of the authorisation and clearing request message may comprise other types of data regarding the payment transaction, either in addition to, or alternatively to, one or more of the data listed on Table 1.

Although it has been shown, in FIG. 4, that the method 400 comprises the step 414 of transmitting, from the merchant 102 to the acquirer 104, a batch list and a draft capture for all the payment transactions involving the acquirer 104, in some arrangements said step is optional.

According to some arrangements as the ones shown in FIGS. 3 and 4, after the clearing process has been successfully completed at the clearing server 106, the clearing server 106 further transmits, to the issuer 108, a clearing confirmation message, wherein the clearing confirmation message indicates that the clearing process of the payment transaction has been successful and that the completion of the payment transaction (i.e., the reconciliation and settlement steps) is authorised.

As will be appreciated based on the specification herein, the above-described arrangements of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed arrangements of the disclosure. The article of manufacture containing the computer code may be made and/or used by executing the code directly from one medium, by copying the code from one medium to another medium, or by transmitting the code over a network.

While the disclosure has been described in terms of various arrangements, the person skilled in the art will recognise that the disclosure can be practiced with modification within the spirit and scope of the claims.

Further aspects of the invention will now be described herein in the following clauses (not claims).

Clause 1. A computer-implemented method for providing an update regarding a clearing status of a payment transaction, the method comprising:
receiving, at a clearing server, from an acquirer, a clearing request message, wherein the clearing request message comprises a request to initiate clearing of the payment transaction between the acquirer and an issuer;
processing, at the clearing server, the clearing of the payment transaction in response to receiving the clearing request message;
generating, at the clearing server, a clearing request response message, wherein the clearing request response message comprises an acknowledgment of the clearing request message and a clearing status indicator, the clearing status indicator comprising an indication of a status of the clearing as a result of an outcome of the processing step;
transmitting, from the clearing server to the acquirer, the clearing request response message, such that the acquirer can take action based on the clearing request response message.

Clause 2. The computer-implemented method of clause 1, wherein, prior to the receiving step, the method comprises:
generating, by the issuer an authorisation response message, in response to the issuer receiving an authorisation request message from the acquirer via an authorisation server; and
transmitting, from the issuer to the acquirer, the authorisation response message, via the authorisation server.

Clause 3. The computer-implemented method of clause 1, wherein, prior to the receiving step, the method comprises:
receiving, at the clearing server, from the acquirer, an authorisation request message, the authorisation request message comprising a request to authorise the payment transaction;
transmitting, from the clearing server, to the issuer, the authorisation request message;
receiving, at the clearing server, from the issuer, an authorisation request message response generated by the issuer, the authorisation request response message comprising a confirmation that the payment transaction is authorised by the issuer.

Clause 4. The computer-implemented method of clause 1, wherein the receiving step further comprises receiving, at the clearing server from the acquirer, an authorisation request message, the authorisation request message comprising a request to authorise the payment transaction; and
wherein, after the receiving step and prior to the processing step, the method further comprises the steps of:
transmitting, from the clearing server to the issuer, the authorisation request message;
receiving, at the clearing server from the issuer, an authorisation request response message, the authorisation request response message being generated by the issuer and comprising a confirmation that the payment transaction is authorised by the issuer; and
sending, from the clearing server to the acquirer, the authorisation request response message.

Clause 5. The computer-implemented method of clause 4, wherein the clearing request message received at the clearing server comprises the authorisation request message.

Clause 6. The computer-implemented method of any of clauses 4 to 5, wherein the clearing request response message sent from the clearing server comprises the authorisation request response message.

Clause 7. The computer-implemented method of any preceding clause, wherein the outcome of the processing step is that the clearing process of the payment transaction is successful.

Clause 8. The computer-implemented method of any preceding clause, wherein the action taken by the acquirer, based on the clearing request response message, is to proceed with the completion of the payment transaction.

Clause 9. The computer method of any of clauses 1 to 6, wherein an outcome of the processing step is that the clearing process of the payment transaction is unsuccessful.

Clause 10. The computer-implemented method of clause 9, wherein the clearing status indicator further comprises an error indicator message, the error indicator message being indicative of a reason for the clearing process being unsuccessful.

Clause 11. The computer-implemented method of clause 10, wherein the reason for the clearing process being unsuccessful is one of:
an encoding of the clearing request message is incompatible with the clearing server;
a bitmap of the clearing request message is unsupported by the clearing server;
the clearing server has failed to send a clearing request response message within a pre-determined timeline.

Clause 12. The computer-implemented method of any preceding clause, wherein the clearing request response message further comprises additional payment transaction data, wherein the additional payment transaction data comprises an indication of one or more of:
invalid merchant;
invalid issuer;
invalid acquirer;
an invalid amount of funds to be transferred in the payment transaction;
a lost or stolen payment card associated with the payment transaction;
an expiration of the payment card;
an invalid PIN number of the payment card;
insufficient funds.

Clause 13. A clearing server for providing an update regarding a clearing status of a payment transaction, the clearing server being configured to perform a method with the following steps:
receiving, at a clearing server, from an acquirer, a clearing request message, wherein the clearing request message comprises a request to initiate clearing of the payment transaction between the acquirer and an issuer;
processing, at the clearing server, the clearing of the payment transaction in response to receiving the clearing request message;
generating, at the clearing server, a clearing request response message, wherein the clearing request response message comprises an acknowledgment of the clearing request message and a clearing status indicator, the clearing status indicator comprising an indication of a status of the clearing as a result of an outcome of the processing step;
transmitting, from the clearing server to the acquirer, the clearing request response message, such that the acquirer can take action based on the clearing request response message.

Clause 14. The clearing server of clause 13, wherein the clearing server is further configured to perform, within the receiving step, the following:
receiving, at the clearing server from the acquirer, an authorisation request message, the authorisation request message comprising a request to authorise the payment transaction; and
wherein, after the receiving step and prior to the processing step, the method further comprises the steps of:
transmitting, from the clearing server to the issuer, the authorisation request message; and
receiving, at the clearing server from the issuer, an authorisation request response message, the authorisation request response message being generated by the issuer and comprising a confirmation that the payment transaction is authorised by the issuer;
sending, from the clearing server to the acquirer, the authorisation request response message.

Clause 15. The clearing server of any of clauses 13 to 14, wherein an outcome of the processing step is that the clearing process of the payment transaction is unsuccessful; and
wherein the clearing status indicator further comprises an error indicator message, the error indicator message being indicative of a reason for the clearing process being unsuccessful.

Clause 16. The clearing server of any of clauses 13 to 15, wherein the clearing request response message further comprises additional payment transaction data, wherein the additional payment transaction data comprises an indication of one or more of:
invalid merchant;
invalid issuer;
invalid acquirer;
an invalid amount of funds to be transferred in the payment transaction;
a lost or stolen payment card associated with the payment transaction;
an expiration of the payment card;
an invalid PIN number of the payment card;
insufficient funds.

Clause 17. A non-transitory computer-readable medium comprising instructions which, when executed by a computer, cause the computer to carry out the following method steps:
receive, at a clearing server, from an acquirer, a clearing request message, wherein the clearing request message comprises a request to initiate clearing of the payment transaction between the acquirer and an issuer;
process, at the clearing server, the clearing of the payment transaction in response to receiving the clearing request message;
generate, at the clearing server, a clearing request response message, wherein the clearing request response message comprises an acknowledgment of the clearing request message and a clearing status indicator, the clearing status indicator comprising an indication of a status of the clearing as a result of an outcome of the processing step;
transmit, from the clearing server to the acquirer, the clearing request response message, such that the acquirer can take action based on the clearing request response message.

Clause 18. The non-transitory computer-readable medium of clause 17, wherein the medium further causes the computer to carry out, together with the receive step, the following step:
receive, at the clearing server from the acquirer, an authorisation request message, the authorisation request message comprising a request to authorise the payment transaction; and
wherein, after the receive step and prior to the processing step, the medium further causes the computer to carry out the following steps:
transmit, from the clearing server to the issuer, the authorisation request message;
receive, at the clearing server from the issuer, an authorisation request response message, the authorisation request response message being generated by the issuer and comprising a confirmation that the payment transaction is authorised by the issuer; and
send, from the clearing server to the acquirer, the authorisation request response message.

Clause 19. The non-transitory computer-readable medium of any of clauses 17 to 18, wherein an outcome of the process step is that the clearing process of the payment transaction is unsuccessful; and
wherein the clearing status indicator further comprises an error indicator message, the error indicator message being indicative of a reason for the clearing process being unsuccessful.

1. A computer-implemented method for providing an update regarding a clearing status of a payment transaction, the method comprising:
receiving, at a clearing server, from an acquirer, a clearing request message, wherein the clearing request message comprises a request to initiate clearing of the payment transaction between the acquirer and an issuer;
processing, at the clearing server, the clearing of the payment transaction in response to receiving the clearing request message;
generating, at the clearing server, a clearing request response message, wherein the clearing request response message comprises an acknowledgment of the clearing request message and a clearing status indicator, the clearing status indicator comprising an indication of a status of the clearing as a result of an outcome of the processing step;
transmitting, from the clearing server to the acquirer, the clearing request response message, such that the acquirer can take action based on the clearing request response message.

2. The computer-implemented method of claim 1, wherein, prior to the receiving step, the method comprises:
generating, by the issuer an authorisation response message, in response to the issuer receiving an authorisation request message from the acquirer via an authorisation server; and
transmitting, from the issuer to the acquirer, the authorisation response message, via the authorisation server.

3. The computer-implemented method of claim 1, wherein, prior to the receiving step, the method comprises:
receiving, at the clearing server, from the acquirer, an authorisation request message, the authorisation request message comprising a request to authorise the payment transaction;
transmitting, from the clearing server, to the issuer, the authorisation request message;
receiving, at the clearing server, from the issuer, an authorisation request message response generated by the issuer, the authorisation request response message comprising a confirmation that the payment transaction is authorised by the issuer.

4. The computer-implemented method of claim 1, wherein the receiving step further comprises receiving, at the clearing server from the acquirer, an authorisation request message, the authorisation request message comprising a request to authorise the payment transaction; and
wherein, after the receiving step and prior to the processing step, the method further comprises the steps of:
transmitting, from the clearing server to the issuer, the authorisation request message;
receiving, at the clearing server from the issuer, an authorisation request response message, the authorisation request response message being generated by the issuer and comprising a confirmation that the payment transaction is authorised by the issuer; and
sending, from the clearing server to the acquirer, the authorisation request response message.

5. The computer-implemented method of claim 4, wherein the clearing request message received at the clearing server comprises the authorisation request message.

6. The computer-implemented method of claim 4, wherein the clearing request response message sent from the clearing server comprises the authorisation request response message.

7. The computer-implemented method of claim 1, wherein the outcome of the processing step is that the clearing process of the payment transaction is successful.

8. The computer-implemented method of claim 1, wherein the action taken by the acquirer, based on the clearing request response message, is to proceed with the completion of the payment transaction.

9. The computer method of claim 1, wherein an outcome of the processing step is that the clearing process of the payment transaction is unsuccessful.

10. The computer-implemented method of claim 9, wherein the clearing status indicator further comprises an error indicator message, the error indicator message being indicative of a reason for the clearing process being unsuccessful.

11. The computer-implemented method of claim 10, wherein the reason for the clearing process being unsuccessful is one of:
an encoding of the clearing request message is incompatible with the clearing server;
a bitmap of the clearing request message is unsupported by the clearing server;
the clearing server has failed to send a clearing request response message within a pre-determined timeline.

12. The computer-implemented method of claim 1, wherein the clearing request response message further comprises additional payment transaction data, wherein the additional payment transaction data comprises an indication of one or more of:
invalid merchant;
invalid issuer;
invalid acquirer;
an invalid amount of funds to be transferred in the payment transaction;
a lost or stolen payment card associated with the payment transaction;
an expiration of the payment card;
an invalid PIN number of the payment card;
insufficient funds.

13. A clearing server for providing an update regarding a clearing status of a payment transaction, the clearing server being configured to perform a method with the following steps:
receiving, at the clearing server, from an acquirer, a clearing request message, wherein the clearing request message comprises a request to initiate clearing of the payment transaction between the acquirer and an issuer;
processing, at the clearing server, the clearing of the payment transaction in response to receiving the clearing request message;
generating, at the clearing server, a clearing request response message, wherein the clearing request response message comprises an acknowledgment of the clearing request message and a clearing status indicator, the clearing status indicator comprising an indication of a status of the clearing as a result of an outcome of the processing step;
transmitting, from the clearing server to the acquirer, the clearing request response message, such that the acquirer can take action based on the clearing request response message.

14. The clearing server of claim 13, wherein the clearing server is further configured to perform, within the receiving step, the following:
receiving, at the clearing server from the acquirer, an authorisation request message, the authorisation request message comprising a request to authorise the payment transaction; and
wherein, after the receiving step and prior to the processing step, the method further comprises the steps of:
transmitting, from the clearing server to the issuer, the authorisation request message; and
receiving, at the clearing server from the issuer, an authorisation request response message, the authorisation request response message being generated by the issuer and comprising a confirmation that the payment transaction is authorised by the issuer;
sending, from the clearing server to the acquirer, the authorisation request response message.

15. The clearing server of claim 13, wherein an outcome of the processing step is that the clearing process of the payment transaction is unsuccessful; and
wherein the clearing status indicator further comprises an error indicator message, the error indicator message being indicative of a reason for the clearing process being unsuccessful.

16. The clearing server of claim 13, wherein the clearing request response message further comprises additional payment transaction data, wherein the additional payment transaction data comprises an indication of one or more of:
invalid merchant;
invalid issuer;
invalid acquirer;
an invalid amount of funds to be transferred in the payment transaction;
a lost or stolen payment card associated with the payment transaction;
an expiration of the payment card;
an invalid PIN number of the payment card;
insufficient funds.

17. A non-transitory computer-readable medium comprising instructions which, when executed by a computer, cause the computer to carry out the following method steps:
receive, at a clearing server, from an acquirer, a clearing request message, wherein the clearing request message comprises a request to initiate clearing of the payment transaction between the acquirer and an issuer;
process, at the clearing server, the clearing of the payment transaction in response to receiving the clearing request message;
generate, at the clearing server, a clearing request response message, wherein the clearing request response message comprises an acknowledgment of the clearing request message and a clearing status indicator, the clearing status indicator comprising an indication of a status of the clearing as a result of an outcome of the processing step;
transmit, from the clearing server to the acquirer, the clearing request response message, such that the acquirer can take action based on the clearing request response message.

18. The non-transitory computer-readable medium of claim 17, wherein the medium further causes the computer to carry out, together with the receive step, the following step:
receive, at the clearing server from the acquirer, an authorisation request message, the authorisation request message comprising a request to authorise the payment transaction; and
wherein, after the receive step and prior to the processing step, the medium further causes the computer to carry out the following steps:
transmit, from the clearing server to the issuer, the authorisation request message;
receive, at the clearing server from the issuer, an authorisation request response message, the authorisation request response message being generated by the issuer and comprising a confirmation that the payment transaction is authorised by the issuer; and
send, from the clearing server to the acquirer, the authorisation request response message.

19. The non-transitory computer-readable medium of claim 17, wherein an outcome of the process step is that the clearing process of the payment transaction is unsuccessful; and
wherein the clearing status indicator further comprises an error indicator message, the error indicator message being indicative of a reason for the clearing process being unsuccessful.
